(19) United States
(12) Patent Application Publication
(10) Pub. No.: US 2015/0206121 A1
(43) Pub. Date: Jul. 23, 2015

(54) SHOPPING CART AND SYSTEM

(71) Applicants: BENTSUR JOSEPH, TEL AVIV (IL); AMNON PELEG, Rishon Letzion (IL); DAVID BEN HA-ROSH, ARIEL (IL)

(72) Inventors: BENTSUR JOSEPH, TEL AVIV (IL); AMNON PELEG, Rishon Letzion (IL); DAVID BEN HA-ROSH, ARIEL (IL)

(21) Appl. No.: 14/598,739

(22) Filed: Jan. 16, 2015

Related U.S. Application Data
(60) Provisional application No. 61/929,305, filed on Jan. 20, 2014.

(30) Foreign Application Priority Data
Jul. 16, 2014 (GB) 1412666.8

(51) Int. Cl. G06Q 20/20; G06Q 30/06

(52) U.S. Cl. CPC G06Q 20/208; G06Q 30/0633; G06Q 30/0639; G06Q 30/0641

(57) ABSTRACT

A shopping cart includes a cart platform; a handle bar; wheels; a product scale; a basket resting on the scale independent of any support by the platform; and a user interface. The cart further includes a product sensor with a processor to read product information. The product scale, which weighs the products to ensure correspondence between the product price and its weight, is constituted merely by one or more transducers in operable contact with the basket.

### CROSS REFERENCE TO RELATED APPLICATIONS

The present invention claims priority from U.S. provisional patent application 61/929,305 entitled “Shopping system and cart”, filed on 20 Jan. 2014; and from UK patent application GB 1412666.8 entitled “Shopping cart and system”, filed on 16 Jul. 2014.

### FIELD OF THE INVENTION

The present invention relates to a shopping or collection cart and inter-related operation system.

### BACKGROUND OF THE INVENTION

It is believed that the technology relevant to the present invention is disclosed in: U.S. Pat. No. 8,292,169 (Serjeantson et al., 2012 Oct. 23) “Cart device, system and method for determining the weight of each item carried”; U.S. Pat. No. 5,287,266 (Malec et al., 1994 Feb. 15) “Intelligent shopping cart system having cart position determining capability”; US20130226718 (Ascarrunz et al., 2013 Aug. 29) “Automated market cart”; US20130168426 (Zhang Jianqiang, 2013 Jul. 4) “Supporting device of intelligent terminal equipment and supermarket shopping car”; US20090228363 (Segev, 2009 Sep. 10) “Shopping system and method therefor”; IE520100053 (Gheorghe, 2011 Dec. 21) “Intelligent Trolley”; CN102708489 (Chao Zhang et al., 2012 Oct. 3) “Intelligent supermarket shopping system based on radio frequency identification device (RFID) and 3rd generation telecommunication (3G) fused technique”; CN202541603U (Yan Lu, 2012 Nov. 21) “Shopping cart with electronic scale”; and WO2013134865 (Dharssi Fatehall, 2013 Mar. 19) “System and method for scanning, tracking and collating customer shopping selections”. The above publications are incorporated herein by reference.

### SUMMARY OF THE INVENTION

The present invention provides a shopping or collection cart and inter-related operation system, or shopping system, that allows shoppers to shop and pay for their purchases autonomously.

In accordance with embodiments of one aspect of the present invention there is provided a cart including a cart platform; a handle bar attached to the cart platform; wheels operably attached to the cart platform; a product scale configured to weigh products and to rest on the cart platform; a product receiving portion or basket configured to floatingly or fixedly rest on the scale, directly or indirectly independent of any support by the platform whereby weighing of products placed in the basket is not hindered by the basket's connection to the platform; and a user interface, typically including a touch screen. The cart further includes a product sensor, configured to read product information and having an associated or integrated processor, which controls and processes interaction of cart activities with a shop computer system. The product scale, that weighs the products to ensure correspondence between the product price and weight, is constituted merely by one or more transducers in operable contact with the basket.

In some embodiments, the platform comprises levelling brackets attached thereto configured to provide a level plane for the scale. In some embodiments, the at least one transducer has one or more respectively associated shock absorbers underneath.

In some embodiments, the cart includes an indoor navigation system configured to include a map and/or voice commands for in-store navigation. In some embodiments, the navigation system is configured to provide the shortest path to arrive to the products.

In some embodiments, the navigation system is configured to use imaging of the store. In some embodiments, the imaging of the store includes imaging the user's vicinity and/or goods located in the store. In some embodiments, the imaging system is configured to interact with a system of the store system to identify the location of the shopper.

In some embodiments, the product sensor is configured to provide price per weight in the case of bulk items such as fruits and vegetables. In some embodiments, the product sensor is configured to provide product information selected from the group consisting of: cost of the product; price per weight in the case of the product being bulk items; nutrition information; product content weight and/or volume; analogous products to a selected product; whether the product is on sale; product ingredients; and product warnings including potential allergens, gluten content, artificial sweeteners and colors. In some embodiments, the product sensor is constituted by a barcode reader and/or a RFID sensor.

In some embodiments, the associated or integrated processor of the product sensor is configured to control and process interaction of cart activities with the Internet cloud.

In some embodiments, the user interface comprises an audio interface. In some embodiments, the audio interface comprises a video interface.

In some embodiments, the cart has a payment system, typically including a credit card swipe slot. The cart also may have an interface such as a touch screen computer that it is linked to the shop's computer system. The cart may additionally or alternatively have a microphone and/or speakers for providing and receiving information and/or instructions. The cart further may include one or more scanners (e.g. barcode reader) configured to read the product price, and typically to further provide a variety of product information, which can be displayed on the touch screen. The touch screen can keep a running cost total of the products scanned and placed in the cart. The cart can also be configured to provide a paper receipt, and/or, in conjunction with the system, to provide an electronic receipt.

It is a particular feature of the cart that it has a scale that weighs the products to ensure correspondence between the product price and its weight and that the scale is disposed so that products leaning on the side of the carts collection basket will be accurately weighed. For such purpose, the scale is located below the basket and the basket rests on the scale.

In this regard, it is a particular feature that the scale is design to have a reduced number of force sensors (pressure transducers/load cells) that are integral or associated with the scale. Such sensors can be particularly expensive and the cart, in particular the scale, is configured so that the weight of products on the scale is transferred to a reduced number, preferably minimal number of such force sensors. This feature may be realized by having the scale constituted solely by the transducers, in operable contact with the cart's basket, for example fastened directly to the basket. Hereinafter in the specification and claims the terms force sensor, pressure transducer and load cell—and their derivatives, may be used interchangeably.

For such purpose, in some embodiments, below the basket there can be is disposed a structure for distributing the weight to a single force sensor (pressure transducer); or in some embodiments to two force sensors (pressure transducers), the point being to a reduced number of transducers than otherwise used.

The characteristic weight and the barcode data of each product is wirelessly transmitted to/from the shopping cart's processor to/from the shop's/store's computer system, for example via a WiFi connection.

In some embodiments, the invention is configured receive a shopping list and keep track of purchases made from the shopping list. In some embodiments, the invention is configured to provide the shopper with a map and/or verbal directions to the items listed on the shopping list. In some embodiments, the invention is configured to provide alternative or supplementary products; and may provide advertisements and discounts.

The system includes a feature to allow the shopper to exit with the cart only if payment is made and the weight of the products purchased corresponds to the measured weight. Such feature of the system can be embodied by a scanner of the type used in airport security, which can provide an alarm in the case of any issues and/or control an exit gate.

In some embodiments, the system is also configured to ensure that the cart is being taken by the correct shopper, i.e. carts are not switched between shoppers, intentionally or inadvertently.

In some embodiments, the cart includes a camera that can be used to help identify the shopper and/or used to help identify anyone stealing the cart. In some embodiments, images of a thief or anyone who takes the cart without permission can be broadcast to a website and/or to a computer-based social network of supermarket members or the like. In some embodiments, the camera is configured to provide a live video; and can further include a GPS-type system to locate the cart wherever it is.

Although the present cart and system will be described herein with respect to a supermarket environment, it should be understood that the cart and system could be implemented in a warehouse (to control inventory, theft, etc.) or other appropriate settings. As such, the cart and system can be considered to provide the application of a platform for collecting items and following up with the distribution.

In accordance with embodiments of one aspect of the present invention there is provided a shopping system shopping system including a shopping cart; and an indoor navigation feature associated with the shopping cart. The indoor navigation feature includes an image processor configured to process images of the store and/or the specific environment therein to provide navigation information to the shopper.

In some embodiments, the indoor navigation feature includes a map displayable on a display of the shopping cart and/or voice commands. In some embodiments, the imaging feature is configured to identify goods in the vicinity. In some embodiments, the imaging feature is configured to interact with a store's system within which the cart is situated.

In some embodiments, the shopping system is configured to receive information from a smartphone application or the like. In some embodiments, the smartphone application allows multiple members of a group to separately access and update their shopping list, each one independently from his/her own smartphone.

In accordance with embodiments of one aspect of the present invention there is provided a method of shopping including: (a) reading product information via a product sensor associated with a shopping cart; (b) weighing the product to ensure correspondence between the product price and its weight by placing the product in a basket of the shopping cart, wherein weighing the product entails placing the product into the basket, which is configured to floatingly or fixedly rest on the product scale, directly or indirectly independent of any support by a cart platform whereby weighing of products placed in the basket is not hindered by the basket's connection to the cart platform, and the product scale is constituted merely by one or more transducers; and (c) paying for the products using a payment system operably connected to the shopping cart.

### BRIEF DESCRIPTION OF THE DRAWINGS

The present invention will be understood and appreciated more fully from the following detailed description taken in conjunction with the appended drawings in which:

FIG. 1 is a schematic side view of a shopping cart in accordance with embodiments of the present invention;

FIG. 2 is a diagram illustrating embodiments of the present shopping system; and

FIG. 3 is a perspective view of another embodiment of the present shopping cart.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF THE INVENTION

Illustrative embodiments of the invention are described below. In the interest of clarity, not all features/components of an actual implementation are necessarily described. Embodiments and/or limitations featured in the figures are chosen for convenience or clarity of presentation and are not meant to limit the scope of the invention.

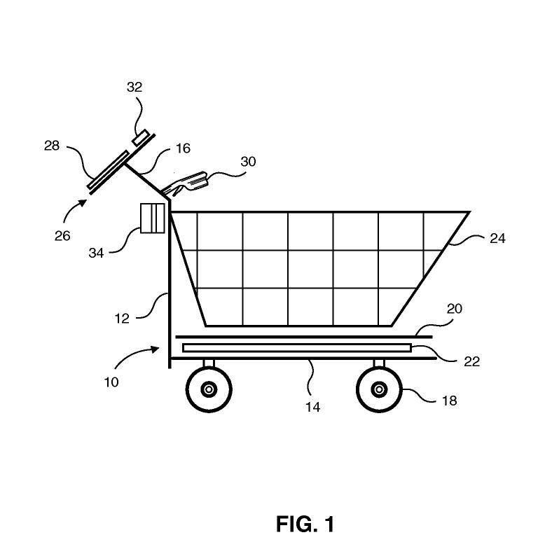

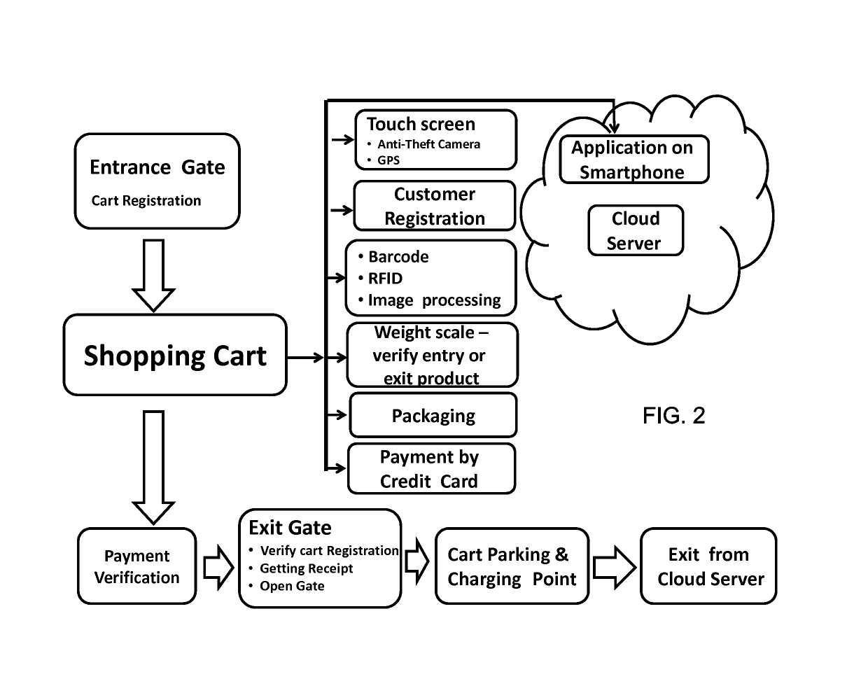

FIG. 1 shows a schematic depiction of a shopping cart in accordance with embodiments of the present invention. The shopping cart includes a cart chassis or platform 10 (typically having an upright portion 12, a generally horizontal portion or base 14, a handle bar 16 attached to the upright portion, and wheels 18 operably attached to the base); a scale 20 (resting on the platform and typically having shock absorbers 22 underneath); a product receiving portion or basket 24 (configured to floatingly or fixedly rest on the scale, directly or indirectly); a display/user interface 26, typically including a touch screen 28, however, additionally or optionally including an audio interface or the like, which could include a video interface; a product sensor 30 (e.g. barcode reader and/or RFID sensor), configured to read the cost of the product (or provide information for determining the cost, e.g. price per weight in the case of bulk items such as fruits and vegetables), and optionally configured to also provide data about the product (e.g. content weight and/or volume, analogous products, if the product is “on sale”; product ingredients; and warnings such as contains potential allergens, gluten, artificial sweeteners or colors, and so forth). Interface 26 has associated or integrated therewith a processor 32, which controls and processes interaction of the cart activities with the shop's computer system and in some preferred embodiments with the Internet cloud (Internet communication network or “cloud server”—FIG. 2).

Regarding connection with “the cloud”, the cart can thus be connected to smartphones and the like whereby an application on the smartphone can communicate with processor 32. Information such as shipping lists; recipes; advertisements, and so on, can thereby be communicated between the shopper and the cart/processor 32.

In particular embodiments of the shopping cart, scale 20 is disposed outside basket 24, for example in order to avoid weighing issues that might occur if a product leans up against a wall of the basket or gets caught on a grill of the wall. Scale 20 is in communication with user interface 26 to provide the user the weight information as well as to ensure that there is correspondence between the measured weight and the expected weight of the product, to avoid store pricing errors or fraud, for example. Scale 20 is configured to properly subtract the weight of basket 24 (i.e. to achieve the tare weight) in order to ensure proper weighing of products.

Basket 24 is attached to the remainder of the cart in a manner whereby the basket can essentially freely move downward with the weight of products accumulating therein. For example, basket 24 may be loosely tethered to platform 10 by a tether (not shown); or interface with a track (not shown) so as not to fix the basket to the platform, rather to allow the basket and its contents to be weighed by scale 20 without hindrance. The bottom of basket 24 and the top of scale 20 may be correspondingly shaped so they are, or can be, fixed to each other.

In some embodiments, the cart further includes a Wi-Fi system that can be used to wirelessly transmit information between the cart's processor and the shop's computer system information, such as the characteristic weight and product data (specifically cost, but other product information as well) of each product scanned at the cart.

In some embodiments, the cart's processor 32 is configured to provide an alarm/warning (audio or other) that the product has not been properly scanned by product sensor 30 (e.g. barcode, RFID chip or image processor) upon sensing that the weight in basket 24 has increased. Analogously, it should be understood that removal of an item from basket 24 also requires scanning to delete the cost of the item. The cart can thus be configured to subtract the cost of a removed item upon scanning, after sensing the decrease in weight in basket 24. In accordance with additional or alternative embodiment, processor 32 can be configured to automatically reduce the price of the removed product if the weight of the product is sufficiently distinct from other products. This feature may be completely automatic or upon confirmation by the shopper via touch screen 28.

In some embodiments, product sensor 30 is configured to recognize each product based on its image and thereby identify the product. The recognized image may be related to the product's shape/dimensions (which may include aspect ratio and such relative dimensions); and/or contours, and/or words and/or writing font and/or colors on the product packaging.

In some embodiments, product sensor 30 and processor 32 are configured to confirm the product identified by its barcode is indeed the product recognized/identified by its image.

In some embodiments, the sensing of an item placed in (or removed from) basket 24 may include a comparison of the expected weight of the item with the actual change in weight indicated by scale 20. This feature could be important if, for example, two items were inserted (or removed) at the same time and only one item was scanned. The weight sensing by scale 20 ensures that products placed in basket 24 have been scanned.

User interface 26 (e.g. touch screen 28), in conjunction with processor 32, can be configured to: (1) indicate the price and weight of the items placed in basket 24; (2) provide information to the shopper about analogous products available; (3) receive information from the shopper (e.g. a shopping list); (4) indicate where products on the shopping list are located in the store (which may include a navigation feature or system; in some embodiments an indoor navigation feature or system as detailed below; (5) suggest complimentary products (e.g. if lunch meat was an item, then sandwich bread might be suggested; and (6) automatically put required items of a recipe on the shopping list.

With reference to item (4) above, the cart or shopping system has an indoor navigation feature can include a map and/or voice commands, providing the shortest path to arrive to the product. In particular embodiments, the navigation feature additionally or alternatively uses imaging (image processing, for example using image processor 30) of the store plan (floor plan/layout) and/or the specific environment/location to provide navigation information to the shopper. The imaging feature can be configured to identify the goods in the purchaser's vicinity, which may thereby be used to provide purchasing information to the user, for example if any such products are on sale and/or a quality report on products in the area, and so on. In some embodiments, the aforementioned image processing is used in conjunction with the store's system to identify the location of the shopper, which can be used for navigation and to promote purchasing, for example, by suggesting newly offered products in the vicinity.

In regard to items (3) and (6), above, user interface 26, with interaction with processor 32, can further be configured to receive information (e.g. a shopping list or recipe) from a smartphone application or the like, so the shopper would not need to input a shopping list on the spot, rather could make the list when convenient, to avoid forgetting desired products and save time in the store. The smartphone application could be programmed to provide information on upcoming sales; new products that have recently come out; and to suggest products based on learned shopping patterns. Further, in some embodiments, the application allows multiple members of a group, e.g. a family, to separately access and update their shopping list, each one independently from his/her own smartphone.

With reference also to FIG. 2, it is a particular feature of some embodiments that the cart includes a camera configured to help identify the shopper and/or used to help identify anyone stealing the cart. The camera is configured to provide a live video to the store's computer system or alternatively an Internet application. The can also include a GPS to help locate the cart if it is not properly placed at the end of the shopping.

In some embodiments, the cart includes a shopping bag dispenser (not shown) whereby packaging of products can be performed conveniently by the customer. In some embodiments, bags or cartons are prearranged in the cart.

With continued reference to FIG. 2, the shopping experience will be described. It is a particular feature of some embodiments of the present invention that it includes an entrance gate or entry system configured to register the cart and electronically match the cart with the shopper. The gate reads identifying information transmitted from the cart and, upon identification of the shopper (e.g. via a credit card swipe 34, FIG. 1), the two are matched. In this way and intentional or inadvertent switching or taking of a cart may be avoided. The cart registration match with the shopper can be verified at an exit gate system, which will be discussed in more detail below.

Leaving the supermarket: the exit gate system, including for example a gatekeeper device similar in design to an airport security gate, verifies that payment has been made and the weight of the purchases corresponds. An exit gate of the exit gate system then opens allowing the shopper to exit the store and bring the cart to the shopper's vehicle, if any, and then to a cart collection point or padlock where the cart is placed and preferably mechanically and electrically connected to the collection point or connected to a cart already located in the collection padlock. In this manner, the carts can be electrically charged for further use. Upon returning the cart, the shopper is “disconnected” from the system.

In addition to the exit gate system ensuring the cart belonged to the shopper who registered it (who took the cart), typically using an electronic sensor, the exit gate system also verifies that payment was made via the cart and the weight and products correlate; and that a payment receipt was generated, prior to opening a gate or automatic door.

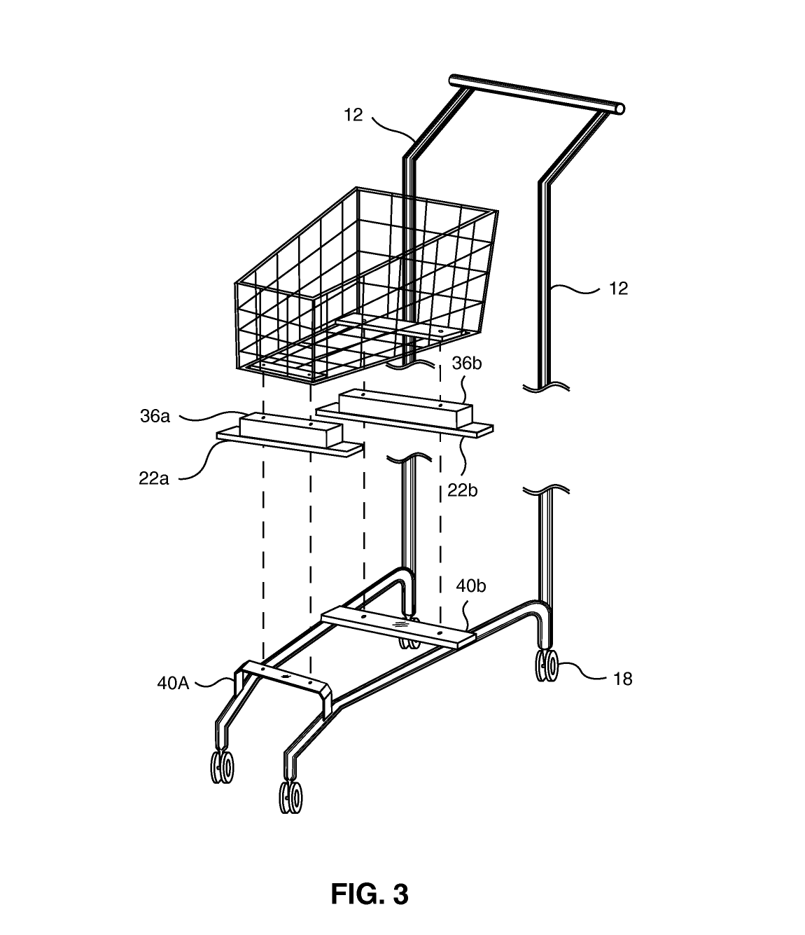

FIG. 3 shows a schematic depiction of another embodiment of the present invention. Instead of scale 20 designed as illustrated in FIG. 1, the scale feature is constituted merely by one or a pair of transducers 36a and 36b (e.g. load cells) attached to and directly below basket 24. In some embodiments, a standard cart can be modified with one or more scale-leveling brackets, exemplified by scale-leveling brackets 40a and 40b, in order to provide a level plane for transducers 36a and 36b. Optional shock absorbing pads 22a and 22b may be included. A design of this type tends to reduce the number of transducers required and thus save costs. It is obviously important that the weighing of the items in basket 24 is not influenced by outside forces such as hindrance of movement of the basket or support other than at the point of contact with transducers 36. It is important to note that basket 26 is not directly attached to chassis 10.

Because basket 24 is not attached directly to chassis 10, the size of the chassis need not be suited specifically to the basket. For example, chassis 10 can be manufactured relatively small to provide the possibility of a compact cart with a small sized basket. However, a medium sized basket or even a large sized basket may be attached. Such design eases production whereby fewer, or ideally only one, chassis size is required to be produced.

In some embodiments, the connection between basket 26 and transducer 36a (or transducers 36a and 36b) can be via a quick connect-disconnect fastener. As such, different sized brackets 26 can be easily changed out on chassis 10. Thus, one scenario, the supermarket could store (or continually provide access to) a variety of sizes of baskets 26 so, for example, if a lot of small sized baskets were in demand, the store, or perhaps the customers themselves, could assemble the carts with baskets of the desired size. The same advantage could be realized at the manufacturing-assembly stage.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

What is claimed is:

1. A cart comprising:
a cart platform;
a handle bar attached to the cart platform;
wheels operably attached to the cart platform;
a product scale configured to weigh products and to rest on the cart platform;
a product receiving portion or basket configured to floatingly or fixedly rest on the scale, directly or indirectly independent of any support by the platform whereby weighing of products placed in the basket is not hindered by the basket's connection to the platform; and
a user interface, typically including a touch screen; and
a product sensor, configured to read product information and having an associated or integrated processor, which controls and processes interaction of cart activities with a shop computer system, wherein the product scale is configured to weigh the products to ensure correspondence between the product price and weight, and is constituted merely by one or more transducers in operable contact with the basket.

2. The cart of claim 1, wherein the platform comprises levelling brackets attached thereto configured to provide a level plane for the scale.

3. The cart of claim 1, wherein the at least one transducer has one or more respectively associated shock absorbers underneath.

4. The cart of claim 1, further comprising an indoor navigation system configured to include a map and/or voice commands for in-store navigation.

5. The cart of claim 4, wherein the navigation system is further configured to provide the shortest path to arrive to the products.

6. The cart of claim 4, wherein the navigation system is further configured to use imaging of the store.

7. The cart of claim 6, wherein imaging of the store comprises imaging the user's vicinity and/or goods located in the store.

8. The cart of claim 6, wherein the imaging system is configured to interact with a system of the store system to identify the location of the shopper.

9. The cart of claim 1, wherein the product sensor is further configured to provide price per weight in the case of bulk items such as fruits and vegetables.

10. The cart of claim 1, wherein the product sensor is further configured to provide product information selected from the group consisting of: cost of the product; price per weight in the case of the product being bulk items; nutrition information; product content weight and/or volume; analogous products to a selected product; whether the product is on sale; product ingredients; and product warnings including potential allergens, gluten content, artificial sweeteners and colors.

11. The cart of claim 1, wherein the product sensor is constituted by a barcode reader and/or a RFID sensor.

12. The cart of claim 1, wherein the associated or integrated processor of the product sensor is configured to control and process interaction of cart activities with the Internet cloud.

13. The cart of claim 1, wherein the user interface comprises an audio interface.

14. The cart of claim 13, wherein the audio interface comprises a video interface.

15. A shopping system comprising:
a shopping cart; and
an indoor navigation feature associated with the shopping cart and including an image processor configured to process images of the store and/or the specific environment therein to provide navigation information to the shopper.

16. The system of claim 15, wherein the indoor navigation feature comprises a map displayable on a display of the shopping cart and/or voice commands.

17. The system of claim 15, wherein the imaging feature is further configured to identify goods in the vicinity.

18. The system of claim 15, wherein the imaging feature is further configured to interact with a store's system within which the cart is situated.

19. The system of claim 15, further configured to receive information from a smartphone application or the like.

20. The system of claim 19, wherein the smartphone application allows multiple members of a group to separately access and update their shopping list, each one independently from his/her own smartphone.

21. A method of shopping comprising:
reading product information via a product sensor associated with a shopping cart;
weighing the product to ensure correspondence between the product price and its weight by placing the product in a basket of the shopping cart, wherein weighing the product entails placing the product into the basket, which is configured to floatingly or fixedly rest on the product scale, directly or indirectly independent of any support by a cart platform whereby weighing of products placed in the basket is not hindered by the basket's connection to the cart platform, and the product scale is constituted merely by one or more transducers; and
paying for the products using a payment system operably connected to the shopping cart.
